(19) United States
(12) Patent Application Publication
(10) Pub. No.: US 2009/0309695 A1
(43) Pub. Date: Dec. 17, 2009

(54) COMPUTING SYSTEM AND COMPUTER-IMPLEMENTED METHOD FOR A MULTI-CARD SYSTEM

(75) Inventor: CHUNG-CHEN PENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/202,343

(22) Filed: Sep. 1, 2008

(30) Foreign Application Priority Data
Jun. 12, 2008 (CN) 200810302113.1

(51) Int. Cl. G06F 7/04

(52) U.S. Cl. 340/5.8

(57) ABSTRACT

A computer-implemented method for a multi-card system is provided. An inserted card detects the operational status of cards of the same type. The inserted card will be in standby status when inserted card finds an active card of the same type. If the inserted card does not find any active card of the same type, the inserted card will send a query to a control card requesting the operational status of the cards of the same type. If the control card accepts the query, the control card will send a signal to the inserted card. The inserted card determines its operational status based on the signal. If the inserted card does not receive the signal in a predetermined amount of time, it will be activated.

### BACKGROUND

1. Field of the Disclosure

Embodiments of the present disclosure relate to a multi-card system, and particularly to a system and method for controlling a operational status of a card in a multi-card system.

2. Description of Related Art

A multi-card system, such as a media access gateway, includes many different types of cards that are controlled by a control card. In general, only one card in each type of cards is activated at a time. If two or more cards of the same type are activated simultaneously, system information may overflow. After a card has been inserted into the multi-card system, the inserted card will detect an operational status of other cards of the same type. The inserted card will be in standby status if the inserted card finds an active card of the same type. If the inserted card does not find an active card of the same type, the inserted card will be activated. However, when the inserted card cannot detect active cards of the same type as the inserted card because they have been disconnected, the inserted card will allow itself to become activated. In this situation, there may be two or more active cards of the same type, and causing the system to become unstable.

What is needed, therefore, is to provide a computer-implemented for a multi-card system that can amend the aforementioned deficiencies.

### BRIEF DESCRIPTION OF THE DRAWINGS

In block S414, the control module 50 controls the control card to reject queries from other cards of the same type as the inserted card.

The foregoing description of the certain inventive embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skill in the art to which the present disclosure pertains without departing from its spirit and scope. Accordingly, the scope of the present disclosure is defined by the appended claims rather than the foregoing description and the embodiments described therein.

FIG. 1 is a block diagram of one embodiment of a computing system for controlling a multi-card system in accordance of the present disclosure.

FIG. 2 is a block diagram of one embodiment of the computing system of FIG. 1 comprising function modules.

FIG. 3 is a flowchart of one embodiment of a computer-implemented for the multi-card system in accordance with the present disclosure.

### DETAILED DESCRIPTION

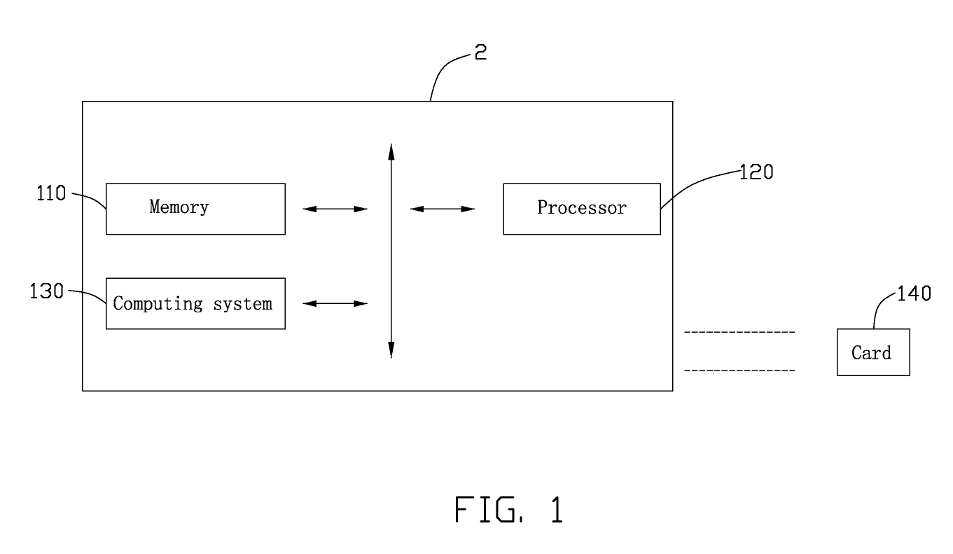

FIG. 1 is a block diagram of one embodiment of a computing system 130 for controlling a multi-card system 2 in accordance of the present disclosure. The computing system 130 may be used to accept computerized commands from a card 140 inserted in the multi-card system 2. The computing system 130 may accept additional computerized commands from other inserted cards of the same type as the card 140 as will be further explained herein below. In one embodiment, the multi-card system 2 may be a media access gateway, for example. The card 140, in one embodiment, may be a Master Control Process (MCP) card or a line card, for example.

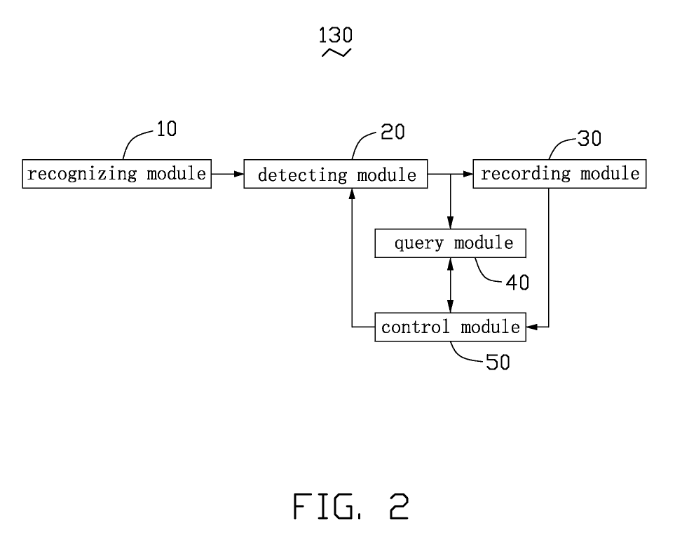

FIG. 2 is a block diagram of one embodiment of the computing system 130 of FIG. 1 comprising function modules. The function modules may be used to control one or more operations of the multi-card system 2. In one embodiment, the computing system 130 comprises a recognizing module 10, a detecting module 20, a recording module 30, a query module 40, and a control module 50. The modules 10, 20, 30, 40, 50 may be used to execute one or more operations for the computing system 130.

The recognizing module 10 is configured for identifying a card type for the card 140 inserted into the multi-card system 2. Depending on the embodiment, the card type may be an MCP card or a line card. In one embodiment, an MCP card acts as a first card type, and a line card acts as a second card type. The second type is inserted into the multi-card system 2. Control parameters are used for indicating a control card to accept queries. The control parameters may be defined by an array t[ ] having one or more indices in the array t[ ]. The control parameters for the MCP card may be defined as t[1], and the control parameters for the line card may be defined as t[2]. The computing system 130 accepts queries from the first type of cards only when a control parameter for the first card type t[1] is equal to zero. The control card accepts queries from the second type of cards only when a control parameter for the second card type t[2] is equal to zero. A initial query time parameter t1 is used for recording the time when the card 140 sends an initial query to the control card. A maximum repeating query time parameter T2[1] denotes the maximum repeating query time for the first type of cards. A maximum repeating query time parameter T2[2] denotes the maximum repeating query time for the second type of cards. A query accepted time parameter t2 is used for recording the time when the control card accepts the query from the card 140. A maximum query continuance time parameter T1[1] denotes the maximum query continuance time of the first type of cards. A maximum query continuance time parameter T1[2] denotes the maximum query continuance time of the second type of cards. When the control card accepts the query from the card 140, the control card will not accept the queries from cards of the same type as the card 140 during the maximum query continuance time of the card 140.

The detecting module 20 is configured for controlling the card 140 to detect an operational status of other cards of the same card type as the card 140. In one embodiment, an operational status of a card means that the card has either been activated or is in standby status. A card that has been activated will be in an operational status for providing service, while a card that is in standby status will be idle until no activated card of the same card type as the card 140 exists. If the card 140 finds an active card of the same type, the card 140 will be in standby status. If the card 140 can not find an active card of the same card type, the card 140 can not determine its operational status.

The recording module 30 is configured for recording the operational status of the card 140 after the operational status of the card 140 is determined and then sending a signal to the control module 50 for driving the control module 50 to determine if can accept queries of cards with the same card type as the card 140. The recording module 30, in one embodiment, may record the operational status of the card 140 into a cache system of the multi-card system 2. Depending on the embodiment, the cache system may comprise readable only memory, random access memory, a hard disk drive, a compact disc, for example.

The query module 40 is configured for controlling the card 140 to send a query to a control card when the card 140 can not find an active card of the same type. When the control parameter for the second type t[2] is not equal to zero, the query module 40 determines if the elapsed time between the current time and the initial query time t1 of the card 140 is greater than the maximum repeating query time T2[2] of the card 140. If the elapsed time between the current time and the initial query time of the card 140 is greater than the maximum repeating query time of the card 140, the card 140 becomes activated. If the elapsed time between the current time and the initial query time of the card 140 is less than the maximum repeating query time of the card 140, the query module 40 controls the card 140 to send a query to the control card again. It is understood that the relationship between the maximum repeating query time parameter of the second type T2[2] and the maximum query continuance time parameter of the second type T1[2] can be denoted as T2[2]>=m*T1[2] when there are m cards in the second type.

The control module 50 is configured for controlling the control card to send a signal to the card 140 when the control card accepts the query of the card 140, wherein the signal includes the operational status of the cards of the same type as the card 140. Additionally, the control module 50 is also configured for determining if the elapsed time between the current time and the query accepted time t2 of the card 140 is greater than a maximum query continuance time T1[2] of the card 140. If the elapsed time between the current time and the query accepted time of the card 140 is greater than the maximum query continuance time of the card 140, the control module 50 enables the control card to accept queries from cards of the same type as the card 140 . The control parameter for the second type t[2] is set to zero. If the elapsed time between the current time and the query accepted time of the card 140 is less than the maximum query continuance time of the card 140, the control card can not accept queries from cards of the same type as the card 140. The value of the control parameter for the second type t[2] does not change.

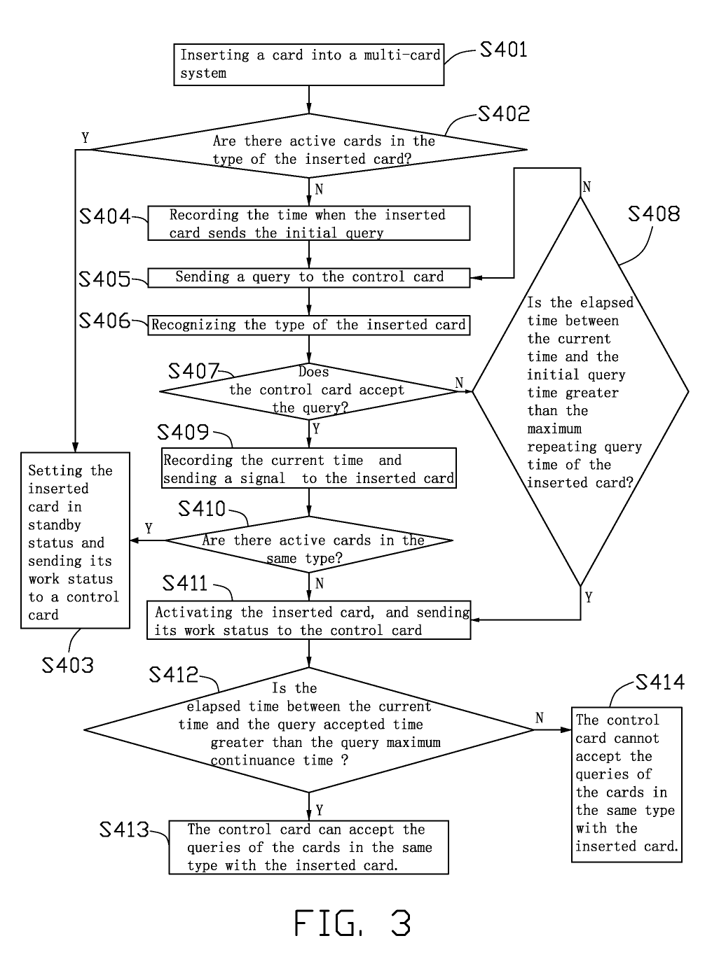

FIG. 3 is a flowchart of one embodiment of a computer-implemented for the multi-card system in accordance with the present disclosure. The method of FIG. 3 may be used to determine one or more operations of the multi-card system 2. Depending on the embodiment, additional blocks may be added, others deleted, and the ordering of the blocks may be changed.

In block S401, the card 140 is inserted into the multi-card system 3. It may be understood that the multi-card system 3 may already have one or more cards inside the system before the card 140 has been inserted into the multi-card system.

In block S402, the inserted card detects a operational status of each of the cards in the multi-card system 3 having a same card type as the card 140. As mentioned above, the operational status of card defines if the card has been activated or in standby. If all cards of the same type are in standby status, block S404 is executed. Otherwise, if all cards of the same type are not in standby status block S403 is executed.

In block S403, the recording module 30 records the standby status of the card 140 and then sending a signal to the control module 50 for driving the control module 50 to determine if can accept queries of cards with the same type as the card 140.

In block S404, the recording module 30 records the current time as the initial query time parameter t1.

In block S405, the query module 40 controlling the inserted card to send a query to the control card for requesting the operational status of the cards of the same type, wherein the query includes the card type and card ID.

In block S406, the control module 50 controls the control card to recognize the type and ID of the inserted card based on the query.

In block S407, assuming that the inserted card belongs to the second type card, the control module 50 controls the control card to determine if the control card accepts the query according to the control parameter t[2]. If the control parameter for the inserted card t[2] is equal to zero, the control card accepts the query, block S409 is executed, otherwise, the control card does not accept the query, block S408 is executed.

In block S408, the control module 50 controls the inserted card to determine if the elapsed time between the current time and the initial query time parameter t1 is greater than the maximum repeating query time parameter T2[2] of the inserted card. If the elapsed time between the current time and the initial query time parameter t1 is greater than the maximum repeating query time parameter T2[2] of the inserted card, block S411 is executed, otherwise, block S405 is executed.

In block S409, the recording module records the current time as the query accepted time parameter t2. The control module 50 sets the current time as the control parameter t[2] for the inserted card. The control module 50 controls the control card to send a signal to the inserted card, wherein the signal includes the operational status of the cards of the same type as the inserted card.

In block S410, the detecting module 20 controls the inserted card to determine if there are active cards of the same type. If there are no active cards of the same type, block S411 is executed, otherwise, block S403 is executed.

In block S411, the recording module 30 records the activation status of the inserted card, and sends the operational status to of the inserted card to the control card.

In block S412, when the control card receives the operational status of the inserted card, the control module 50 controls the control card to determine if the elapsed time between the current time and the query accepted time parameter t2 is greater than the maximum query continuance time parameter of the inserted card T1[2]. If the elapsed time between the current time and the query accepted time parameter t2 is greater than the maximum query continuance time parameter of the inserted card T1[2], block S413 is executed, otherwise, block S414 is executed.

In block S413, the control module 50 sets zero as the control parameter for the inserted card to enable the control card to accept queries from the other cards of the same type as the inserted card.

What is claimed is:

1. A computing system for controlling a multi-card system comprising:
a recognizing module configured for identifying a card type for a card inserted into the multi-card system;
a detecting module configured for controlling the inserted card so as to detect a operational status of other cards in the multi-card system having the same card type as the inserted card;
a recording module configured for recording an operational status of the inserted card into a cache system;
a query module configured for controlling the inserted card to send a query to a control card in the multi-card system;
a control module configured for controlling the control card so as to send a signal to the inserted card, wherein the signal includes the operational status of the cards having the same card type as the inserted card, wherein the inserted card will be in standby status upon the condition that the inserted card finds an active card of the same card type as the inserted card; and
the query module further configured for controlling the inserted card to send a query to a control card in the multi-card system upon the condition that the inserted card can not find an active card of the same card type; the control module controls the control card to send a signal to the inserted card, wherein the signal includes the operational status of the cards of the same card type as the inserted card.

2. The computing system as claimed in claim 1, wherein the control module controls the control card to send a signal to the inserted card upon the condition that the control card accepts the query of the inserted card, wherein the signal includes the operational status of the cards of the same card type as the inserted card; wherein the query module determines if the elapsed time between the current time and a initial query time of the inserted card is greater than a maximum repeating query time of the inserted card upon the condition that the control card does not accept the query from the inserted card; wherein the inserted card becomes activated upon the condition that the elapsed time between the current time and the initial query time of the inserted card is greater than the maximum repeating query time of the inserted card; wherein the inserted card becomes inactivated upon the condition that the elapsed time between the current time and the initial query time of the inserted card is less than the maximum repeating query time of the inserted card.

3. The computing system as claimed in claim 1, wherein the recording module send a signal to the control module after recording the work status of the inserted card; wherein the control module determines if the elapsed time between the current time and the query accepted time of the inserted card is greater than a maximum query continuance time of the inserted card; wherein the control module enables the control card to accept queries from cards of the same card type as the inserted card upon the condition that the elapsed time between the current time and the query accepted time of the inserted card is greater than the maximum query continuance time of the inserted card; wherein the control module disables the control card to accept queries from cards of the same card type as the inserted card upon the condition that the elapsed time between the current time and the query accepted time of the inserted card is less than the maximum query continuance time of the inserted card.

4. The computing system as claimed in claim 1, wherein the multi-card system is a media access gateway.

5. A computer-implemented method for controlling a multi-card system, the method comprising:
detecting an insertion of a card in the multi-card system;
detecting if there are active cards of the same card type as the inserted card;
setting the inserted card in a standby status upon the condition that there are active cards of the same card type;
sending a query to the control card requesting a operational status of one or more cards of the same card type as the inserted card upon the condition that all cards of the same card type are in the standby status, and recording an initial query time of the query;
recognizing the card type of the inserted card based on the query, and determining if the control card accepts the query;
determining if an elapsed time between a current time and the initial query time is greater than a maximum repeating query time of the inserted card upon the condition that the control card does not accept the query, wherein the inserted card is activated upon the condition that the elapsed time between the current time and the initial query time is greater than the maximum repeating query time of the inserted card;
recording the query accepted time upon the condition that the control card accepts the query, and sending a signal to the inserted card, wherein the signal includes the operational status of the cards of the same card type as the inserted card;
determining if there are active cards of the same card type as the inserted card;
setting the inserted card in a standby status upon the condition that there are active cards of the same type; and
activating the inserted card upon the condition that all cards of the same card type are in the standby status.

6. The computer-implemented method as claimed in claim 5, wherein the query includes the card type of the inserted card.

7. The computer-implemented method as claimed in claim 5, wherein the maximum repeating query time defines a maximum repeating query time of all card types of the one or more cards in the multi-card system, wherein queries of the inserted card are repeatedly sent in the maximum repeating query time upon the condition that the control card does not accept the initial query.

8. The computer-implemented method as claimed in claim 5, wherein sending the operational status of the inserted card to the control card after determining the operational status of the inserted card.

9. The computer-implemented method as claimed in claim 5, wherein a maximum query continuance time parameter denotes the maximum query continuance time of all types of cards, wherein rejecting queries from other cards of the same card type as the inserted card in the maximum query continuance time of the inserted card upon the condition that accepting the query from the inserted card.

10. The computer-implemented method as claimed in claim 6, wherein determining if the elapsed time between the current time and the query accepted time is greater than the maximum query continuance time of the inserted card; accepting queries from the type of the inserted card upon the condition that the elapsed time between the current time and the query accepted time is greater than the maximum query continuance time of the inserted card; wherein rejecting the queries from the cards of the same type as the inserted card upon the condition that the elapsed time between the current time and the query accepted time is less than the maximum query continuance time of the inserted card.

11. The computer-implemented method as claimed in claim 7, wherein the maximum repeating query time parameter of each type is equal to or greater than the product of the number of cards for each type and the maximum query continuance time parameter of each type.

12. The computer-implemented system as claimed in claim 5, wherein the multi-card system is a media access gateway.
